(19) United States
(12) Patent Application Publication
(10) Pub. No.: US 2026/0063448 A1
(43) Pub. Date: Mar. 5, 2026

(54) INDUCTIVE POSITION MEASURING DEVICE

(71) Applicant: DR. JOHANNES HEIDENHAIN GmbH, Traunreut (DE)

(72) Inventors: Matthias ECKART, Anger (DE); Christoph HEINEMANN, Übersee (DE); Christof KLAPPAUF, Ainring (DE)

(21) Appl. No.: 19/307,424

(22) Filed: Aug. 22, 2025

(30) Foreign Application Priority Data
Aug. 29, 2024 (EP) 24197213.2

(51) Int. Cl. G01D 5/20

(52) U.S. Cl. CPC G01D 5/20

(57) ABSTRACT

An inductive position measuring device includes a first assembly having a first interaction surface and a second assembly having a second interaction surface. The two assemblies are arranged opposite each other in a third direction and are movable relative to each other. The first assembly includes multiple first field interaction devices arranged parallel to the first interaction surface and connected to evaluation electronics. The second assembly includes multiple second field interaction devices arranged in a flat manner distributed over the second interaction surface. The inductive position measuring device includes at least four first field interaction devices in the form of linear sensors arranged as a quadrilateral along a first and second direction, and the first field interaction devices overlap at least partially in the corners of the quadrilateral arrangement.

### CROSS-REFERENCE TO RELATED APPLICATIONS

The present application claims priority to application Ser. No. 24/197,213.2, filed in the European Patent Office on Aug. 29, 2024, which is expressly incorporated herein in its entirety by reference thereto.

### FIELD OF THE INVENTION

The present invention relates to an inductive position measuring device.

### BACKGROUND INFORMATION

A movement device having a stationary assembly, a movable assembly, and a position determination system is described in PCT Patent Document No. WO 2020/088869. Both assemblies have their own power supply and include multiple circularly configured coils or capacitor plates that interact electromagnetically with each other.

A disadvantage is that both the movable and stationary assemblies use electrical components that must be connected to active electronics. This means that each assembly requires its own power supply and data connection, which leads to a significantly more complex configuration, particularly for stationary assemblies.

### SUMMARY

Example embodiments of the present invention provide an inductive position measuring device, in which the position of a movable assembly can be determined in multiple degrees of freedom and which is also inexpensive to produce.

According to example embodiments, an inductive position measuring device includes a first assembly having a first interaction surface and a second assembly having a second interaction surface. The two assemblies are arranged opposite each other in a third direction and are movable relative to each other. The first assembly includes multiple first field interaction devices arranged parallel to the first interaction surface and connected to evaluation electronics. The second assembly includes multiple second field interaction devices, which are arranged in a flat manner distributed over the second interaction surface. The first and second field interaction devices can be brought into electromagnetic interaction. The inductive position measuring device includes at least four first field interaction devices in the form of linear sensors, which are arranged as a quadrilateral along a first and second direction, and the first field interaction devices overlap at least partially in the corners of the quadrilateral arrangement.

According to example embodiments, each first field interaction device includes at least one excitation device configured to generate an electromagnetic field and at least one receiver configured to receive an electromagnetic field.

For example, each first field interaction device includes a first receiver and a second receiver, which have a periodic curve with a constant period length, in which the receivers are arranged in the first or second direction offset from each other by a quarter of their period length, and an excitation device surrounding the two receivers, e.g., in the form of a quadrilateral.

For example, the first assembly includes four first field interaction devices arranged in the first interaction surface and perpendicular to each other.

In a configuration in which four first field interaction devices are provided, the receivers of the four first field interaction devices may be configured such that their peak-to-peak amplitude corresponds to at least one period length.

Alternatively, the first assembly includes eight first field interaction devices arranged in the first interaction surface and in pairs parallel to field interaction pairs, and the four field interaction pairs are arranged perpendicular to each other.

In a configuration in which eight field interaction devices or four field interaction pairs is provided, the first receivers of at least one of the field interaction pairs may be configured identically and may be connected in series. In addition, the second receivers of at least one of the field interaction pairs are configured identically and are connected in series. The peak-to-peak amplitude of at least one of the receivers is less than half the period length, and the distance between the two first receivers or the two second receiver of at least one field interaction pair is half the period length.

The foregoing refers to the distance within a field interaction pair that is arranged between the receiver of one first field interaction device and the receiver of the further first field interaction device with respect to the virtual zero crossings.

For example, in each of the four field interaction pairs, the first receivers are configured identically, and the first receivers of a field interaction pair are connected in series. In a similar manner, in each of the four field interaction pairs, the second receivers are, for example, identical, and the first receivers in a field interaction pair are connected in series.

For example, the second field interaction devices are arranged as quadrangular, e.g., square, areas, are of equal size, and are arranged in a grid-like manner evenly distributed on the second interaction surface.

For example, the quadrilateral of the quadrilateral arrangement is a rectangle, e.g., a square.

For example, the second field interaction devices are produced using planar technology, e.g., by a thick film technique and, additionally or alternatively, a thin film technique.

For example, the first field interaction devices may be operated alternately by the evaluation electronics at a predetermined switching frequency.

For example, the predetermined switching frequency is dependent on the current relative speed and, additionally or alternatively, the historical (i.e., past) relative speeds of the first and, additionally or alternatively, the second assembly.

It may also be provided that the evaluation electronics include at least one signal generator module, at least one evaluation module, and at least one switching unit. The first field interaction devices are connected via the at least one switching unit either individually or in pairs, either to the evaluation module or to the signal generator module.

According to example embodiments, the switching unit includes at least one multiplexer and at least one control module, and the control module controls the at least one multiplexer depending on the switching frequency such that a pairwise connection of the first field interaction devices extending in an identical direction with the evaluation module or the signal generation module takes place.

For example, the second assembly is not connected to an active power supply device and data processing device.

Thus, only the first assembly is connected to an active power supply device and data processing device.

Further features and aspects of example embodiments of the present invention are explain in more detail below with reference to the appended schematic Figures.

### BRIEF DESCRIPTION OF THE DRAWINGS

FIG. 1 is a perspective view of an inductive position measuring device including a first assembly and a second assembly.

FIG. 2 is a top view of the second assembly.

FIG. 3 is a top view of a first field interaction device.

FIG. 4 is a top view of a first field interaction device.

FIG. 5 illustrates a first interaction surface of a first assembly.

FIGS. 6a and 6b are top views of an inductive position measuring device, in which a relative rotation of a first assembly about the coordinate axis of the third direction is illustrated.

FIG. 7 is a block diagram of the evaluation electronics of the first module of the inductive position measuring device.

### DETAILED DESCRIPTION

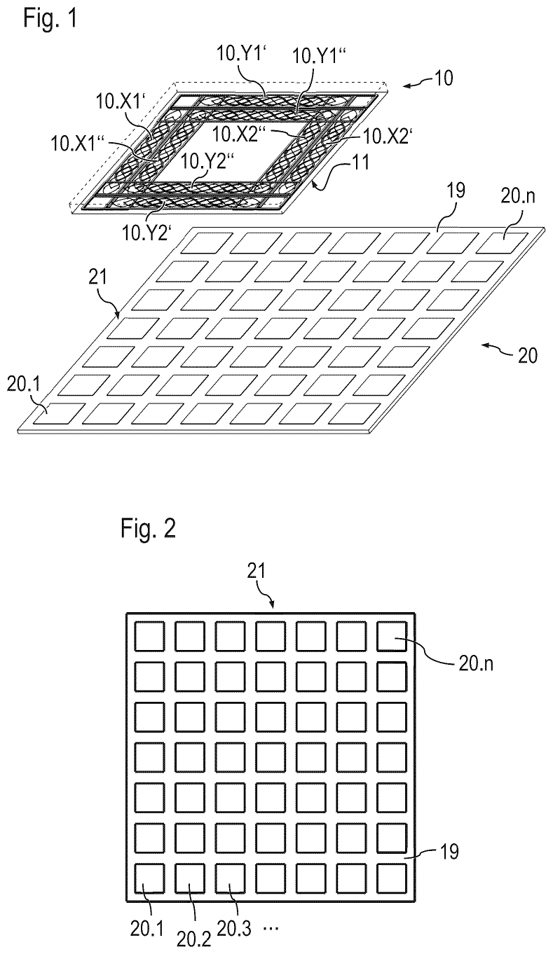

As illustrated in FIG. 1, the inductive position measuring device 1 includes a first assembly 10 and a second assembly 20, which are opposite each other in a third direction z and which are movable relative to each other. The first assembly 10 and the second assembly 20 are arranged at a distance from each other, so that an air gap is located between the two assemblies 10, 20.

The first assembly 10 includes a first interaction surface 11 having multiple first field interaction device 10.X1′, 10.X1″, 10.X2′, 10.X2″, 10.Y1′, 10.Y1″, 10.Y2′, 10.Y2″, in which the first field interaction devices 10.X1′, 10.X1″, 10.X2′, 10.X2″, 10.Y1′, 10.Y1″, 10.Y2′, 10.Y2″ are arranged parallel to and flush within the first interaction surface 11. The first module 10 is supplied with electrical energy to generate at least one excitation signal S1 and to receive at least one received signal S2. This can be done via a cable or wirelessly, for example. The energy source may, for example, be a battery within the first assembly 10 or may be located outside the first assembly 10.

The second assembly 20 includes a second interaction surface 21 with multiple second field interaction devices 20.1 to 20.n. The second field interaction devices 20.1 to 20.n are arranged on or flush within the second interaction surface 21 and are distributed over its surface. The second module 20 does not independently form its own magnetic field and is also not actively supplied with electrical energy via cables, etc., as the second module 20 interacts purely passively with the first module 10.

The second interaction surface 21 of the second assembly 20 is generally configured to be larger than the first interaction surface 11 of the first assembly 10, so that there is always sufficient overlap between the two assemblies 10, 20 even when the first assembly 10 is positioned in the edge area of the second assembly 20.

The two interaction surfaces 11, 21 are arranged opposite each other and are spaced apart such that position determination is possible by electro-magnetic interaction between the first and second field interaction devices 10.X1′, 10.X1″, 10.X2′, 10.X2″, 10.Y1′, 10.Y1″, 10.Y2′, 10.Y2″ and 20.1 to 20.n. For example, this is the case in the condition that the first and second field interaction devices 10.X1′, 10.X1″, 10.X2′, 10.X2″, 10.Y1′, 10.Y1″, 10.Y2′, 10.Y2″ or 20.1 to 20.n at least partially overlap in the third direction z viewed from above.

During operation of the inductive position measuring device 1, the position and orientation of the assemblies 10, 20 relative to each other can change in the three directions x, y, z. For example, the three directions x, y, z are orthogonal to each other. Through the electromagnetic interaction of the first field interaction devices 10.X1′, 10.X1″, 10.X2′, 10.X2″, 10.Y1′, 10.Y1″, 10.Y2′, 10.Y2″ with the second field interaction devices 20.1 to 20.n, the current position and orientation in six degrees of freedom is determined and evaluated by the inductive position measuring device 1. Evaluation electronics are provided inside or outside the first assembly 10 for evaluating the position and orientation of the first assembly 10. Data can be transmitted, for example, by cable or alternatively wirelessly.

For example, one of the assemblies is immobile and stationary, whereas the other assembly is freely movable. For example, the second interaction surface 21 of the second assembly 20 may be multiple times larger than the first interaction surface 11 of the first assembly 10, in which case the second assembly may be arranged as immobile and stationary. Alternatively, however, the first assembly 10 may also be arranged immobile and stationary, and the second assembly 20 may be movable relative to the first assembly 10. This is beneficial, for example, if it is not possible to supply the moving assembly with electrical energy.

FIG. 2 illustrates an arrangement of the second interaction surface 21 of the second assembly 20. The second interaction surface 21 may have any topography or be curved as appropriate, and it may be, for example, flat.

The second interaction surface 21 is, for example, the surface of a circuit board produced by a thin-film technique and, additionally or alternatively, a thick-film technique. The circuit board includes an electrically insulating base material 19, for example, a fiber-reinforced epoxy resin. An electrically conductive layer, e.g., made of copper, is applied to the base material 19 of the circuit board and is structured such that multiple second interaction devices 20.1 to 20.n are provided.

Alternatively, the individual second field interaction devices 20.1 to 20.n and the second interaction surface 21 may also be provided by a substrate. For example, this may be a metal substrate in which the individual second field interaction devices 20.1 to 20.n are provided in the form of elevations, wherein no metal substrate is present between the individual second field interaction devices 20.1 to 20.n. The regions between the individual second field interaction devices 20.1 to 20.n may be arranged as empty space or an air gap or, for example, may be filled with an epoxy resin so that a flat surface is formed.

The second field interaction devices 20.1 to 20.n are arranged in the form of a square grid distributed over the second interaction surface 21 and have a defined distance from each other. The columns and rows from the second field interaction devices 20.1 to 20.n of the grid are arranged along the orthogonally extending first and second direction x, y. All second field interaction devices 20.1 to 20.n have identical dimensions, e.g., in the form of squares. However, other shapes are also possible, such as circles, rectangles, spirals, etc.

The grid may be completely filled with second field interaction devices 20.1 to 20.n, as illustrated in FIG. 2, so that the second field interaction devices 20.1 to 20.n are evenly distributed in a grid-like manner. Alternatively, the second field interaction devices 20.1 to 20.n may also be distributed unevenly over the second interaction surface 21, so that the grid includes, for example, individual locations or regions without second field interaction devices 20.1 to 20.n.

For example, each second field interaction device 20.1 to 20.n is structurally identical, and all second field interaction devices 20.1 to 20.n are arranged equidistantly from each other in a grid.

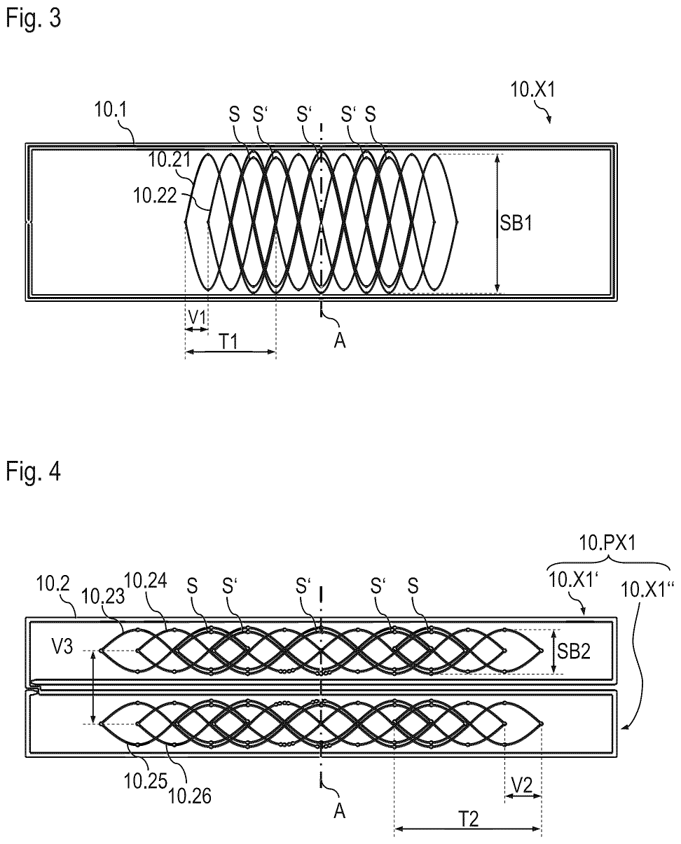

FIG. 3 illustrates a first exemplary arrangement of the first field interaction devices 10.X1, 10.X2, 10.Y1, 10.Y2. The first field interaction device 10.X1 is illustrated as an elongated linear sensor including a planar excitation device 10.1 configured to generate electromagnetic fields and two planar receivers 10.21, 10.22 configured to receive electromagnetic fields.

The first receiver 10.21 is arranged as a receiving conductive path and includes multiple conductive path sections. The basic curve of the first receiver 10.21 is structurally similar to a sinusoidal curve, in which the magnitude of the individual conducting path amplitudes is not necessarily structurally constant. Two adjacent conducting path amplitudes of the basic curve—including or consisting of a positive and a negative conducting path amplitude—have a period length T1 and a peak-to-peak amplitude SB1.

The first receiver 10.21 can be divided into a forward section and a return section. The forward section is similar in its basic curve to the graph of the function ƒ(x)=a·sin(x) with a∈ [symbol] ⁺. The return section is similar in its basic curve to the graph of the function g (x)=−a·sin (x), with a∈ [symbol] ⁺. This means that the return section of the first receiver 10.21 approximately corresponds to the forward section mirrored on a line of symmetry.

The second receiver 10.22 is configured in similar manner as the first receiver 10.21 as a receiving conductive path but is arranged offset by a quarter of the period length T1 relative to the first receiver 10.21 (offset V1). The offset V1 occurs, for example, along the first direction x or along the second direction y. The offset arrangement of the two receivers 10.21, 10.22 provides correspondingly phase-shifted signals to be generated. The two receivers 10.21, 10.22 are electrically connected such that they supply a 0° signal and a 90° signal.

The two receivers 10.21, 10.22 differ in length from each other. For example, the first receiver 10.21 has a length of three periods, each with the period length T1, and the second receiver 10.22 has a length of two and a half periods, each with the period length T1.

In addition to a sinusoidal curve of the receivers 10.21, 10.22, alternative curve shapes are also possible, for example, a triangular curve, etc.

The peak-to-peak amplitude SB1 for the receivers 10.21, 10.22 corresponds to the magnitude of the deflection between the minimum value and the maximum value within a period length T1. It is arranged perpendicular to the direction of the period length T1 or perpendicular to the first or second direction x, y.

According to the first exemplary arrangement of the first field interaction devices 10.X1, 10.X2, 10.Y1, 10.Y2, the peak-to-peak amplitudes SB1 of the first receiver 10.21 and the peak-to-peak amplitudes SB1 of the second receiver 10.22 are equal on average and correspond at least to the period length T1.

The receivers 10.21, 10.22 illustrated in FIG. 3 have peak-to-peak amplitudes SB1 that correspond to approximately 1.5 times the period length T1.

The two receivers 10.21, 10.22 are arranged as multiple conductive path sections in different layers of a carrier substrate. Details of such a multilayer structure including or consisting of conductive path sections are described in European Patent Document No. 4 530 851 and U.S. Patent Application Publication No. 2025/0109969, each of which is expressly incorporated herein in its entirety by reference thereto.

To compensate for yaw tilts, the receivers 10.21, 10.22 may, in some places, have additional loops S, S′, which are also formed from conductive path sections. For this purpose, the loops S, S′ are placed below the conductive path amplitudes at predetermined points along the basic curve. At points with the additional loops S, S′, the conducting path amplitudes of the receivers 10.21, 10.22 deviate from the basic curve and are shifted by a predetermined amount outwardly, i.e., in the direction of the excitation device 10.1. The loops S, S′ are slightly shifted inwardly with respect to the conducting path amplitudes of the basic curve, i.e., in the direction of the virtual zero crossing of the basic curve of the receivers 10.21, 10.22. However, a structurally deviating conducting path amplitude with a loop nevertheless results in an amplitude signal of identical magnitude to that of a normal conducting path amplitude without a loop.

The loops S, S′ are part of the receiving conductive path and are, for example, arranged on the first field interaction devices 10.X1, 10.X2, 10.Y1, 10.Y2 such that they are arranged mirror-symmetrically with respect to an axis A, which divides the forward and return sections into equal parts.

The loops S of the first receivers 10.21 may be arranged either within the forward section and, additionally or alternatively, within the return section of the receiving conductive path.

The loops S′ of the second receiver 10.21 may also be arranged either within the forward section and, additionally or alternatively, within the return section of the receiving conductive path.

The two receivers 10.21, 10.22 are bounded by the excitation device 10.1, i.e., surrounded on all sides. The excitation device 10.1 is arranged as an excitation conductive path and has a square or rectangular shape.

According to a second exemplary arrangement of the first field interaction devices 10.X1′, 10.X1″, 10.X2′, 10.X2″, 10.Y1′, 10.Y1″, 10.Y2′, 10.Y2″, they may also be arranged to form field interaction pairs 10.PX1, 10.PX2, 10.PY1, 10.PY2.

The field interaction pair 10.PX1 illustrated in FIG. 4 includes the first field interaction device 10.X1′ and the further first field interaction device 10.X1″. The two first field interaction devices 10.X1′, 10.X1″ are arranged as elongated linear sensors and together form a planar excitation device 10.2 (illustrated in FIG. 4) or, alternatively, a planar excitation device configured to generate electromagnetic fields.

The first field interaction device 10.X1′ includes a planar first receiver 10.23 and a planar second receiver 10.24 configured to receive electromagnetic fields. The further first field interaction device 10. X′ as well includes a planar first receiver 10.25 and a planar second receiver 10.26 configured to receive electromagnetic fields.

The first field interaction devices 10.X1′, 10.X1″ are arranged at a distance from each other so that an offset V3 is formed between the two first field interaction devices 10.X1′, 10.X1″ with respect to the receivers 10.23, 10.24 and the receivers 10.25, 10.26. The offset V3 is provided, for example, along the first direction x or along the second direction y. For example, the offset V3 corresponds to half a period length T2.

The configuration of the first field interaction devices 10.X1′, 10.X1″, 10.X2′, 10.X2″, 10.Y1′, 10.Y1″, 10.Y2′, 10.Y2″, according to the second exemplary arrangement and their arrangement into field interaction pairs 10.PX1, 10.PX2, 10.PY1, 10.PY2 ensures that the cross-sensitivity of the inductive measuring device 1 is reduced. For example, cross-sensitivity perpendicular to the direction x or to the direction y is reduced.

The first receivers 10.23, 10.25 are arranged as receiving conductive paths and are composed of multiple conductive path sections. The basic curve of the first receivers 10.23, 10.25 is similar to a sinusoidal curve, in which the magnitude of the individual conducting path amplitudes is not necessarily structurally constant. Two adjacent conducting path amplitudes of the basic curve—including or consisting of a positive and a negative conducting path amplitude—have a period length T2 and a peak-to-peak amplitude SB2.

The first receivers 10.23, 10.25 may be divided into a forward section and a return section. A forward section is similar in its basic curve to the graph of the function ƒ(x)=a·sin (x), with a∈ [symbol] ⁺. A return section is similar in its basic curve to the graph of the function g(x)=−a·sin (x), with a∈ [symbol] ⁺. This means that a return section of the first receivers 10.23, 10.25 approximately corresponds to a forward section mirrored on a line of symmetry.

The second receivers 10.24, 10.26 are configured similar to the first receivers 10.23, 10.25 as a receiving conductive path, but are arranged offset by a quarter of the period length T2 relative to the associated first receivers 10.23, 10.25 (offset V2). The offset V2 is provided, for example, along the first direction x or along the second direction y. The offset arrangement of the two receivers 10.23, 10.25 or 10.24, 10.26 provides for correspondingly phase-shifted signals to be generated. The two receivers 10.24, 10.26 or the two receivers 10.24, 10.26 are electrically connected such that they supply a 0° signal and a 90° signal.

The two receivers 10.23, 10.25 differ in length from each other. For example, the first receiver 10.23 has a length of three periods, each with the period length T2, and the second receiver 10.25 has a length of two and a half periods, each with the period length T2.

In an configuration of the first field interaction devices 10.X1′, 10.X1″, 10.X2′, 10.X2″, 10.Y1′, 10.Y1″, 10.Y2′, 10.Y2″, according to the second exemplary arrangement, the first receiver 10.23 of the first field interaction device 10.X1′ is connected in series with the first receiver 10.25 of the further first field interaction device 10.X1″. In addition, the second receiver 10.24 of the first field interaction device 10.X1′ is connected in series with the second receiver 10.26 of the further first field interaction device 10.X″. This serial connection results in a 0° signal and a 90° signal with increased signal amplitudes.

In addition to a sinusoidal curve of the receivers 10.23, 10.24, 10.25, 10.26, alternative curve shapes are also possible, for example, a triangular curve, etc.

The peak-to-peak amplitude SB2 for the receivers 10.23, 10.25, 10.24, 10.26 corresponds to the magnitude of the deflection between the minimum value and the maximum value within a period length T2. It extends perpendicular to the direction of the period length T2 or perpendicular to the first or second direction x, y.

According to the second exemplary arrangement of the first field interaction devices 10.X1′, 10.X1″, 10.X2′, 10.X2″, 10.Y1′, 10.Y1″, 10.Y2′, 10.Y2″, the peak-to-peak amplitudes SB2 of a first receiver 10.23, 10.25 and the peak-to-peak amplitudes SB2 of an associated second receiver 10.24, 10.26 are equal on average and correspond to at most half the period length T2.

The receivers 10.23, 10.25, 10.24, 10.26 illustrated in FIG. 3 have peak-to-peak amplitudes SB2 that correspond to approximately one third of the period length T2.

The first and second receivers 10.23, 10.25, 10.24, 10.26 are formed from multiple conductive path sections in different positions of a substrate.

To compensate for yaw tilts, the receivers 10.23, 10.25, 10.24, 10.26 may in some places have additional loops S, S′, which are formed from conductive path sections. For this purpose, the loops S, S′ are placed below the conductive path amplitudes at predetermined points along the basic curve. At points with the additional loops S, S′, the conducting path amplitudes of the receivers 10.21, 10.22 deviate from the basic curve and are shifted by a predetermined amount outwardly, i.e., in the direction of the excitation device 10.1. The loops S, S′ are slightly shifted inwardly with respect to the conducting path amplitudes of the basic curve, i.e., in the direction of the virtual zero crossing of the basic curve of the receivers 10.23, 10.25, 10.24, 10.26. However, in the case of a structurally deviating conducting path amplitude with a loop, the result is an amplitude signal of identical magnitude to that of a normal conducting path amplitude without a loop.

The loops S, S′ are part of a receiving conductive path and are, for example, arranged on the two first field interaction devices 10.X1′, 10.X1″ such that they are arranged mirror-symmetrically with respect to an axis A, which divides a forward or return section into equal parts.

The loops S of the first receivers 10.23, 10.25 may be arranged either within a forward section and, additionally or alternatively, within a return section of the receiving conductive path.

The loops S′ of the second receivers 10.24, 10.26 may also be arranged either within a forward section and, additionally or alternatively, within a return section of the receiving conductive paths.

As explained above, the receivers 10.23, 10.25, 10.24, 10.26 are bounded by either a common excitation device 10.2 or by multiple separate excitation devices, i.e., surrounded on all sides. The excitation device 10.2 is arranged as an excitation conductive path and has a square or rectangular shape.

For example, the one excitation device 10.2 may form two rectangles, e.g., one rectangle around the receivers 10.23, 10.24 and one rectangle around the receivers 10.25, 10.26, as illustrated in FIG. 4. Alternatively, two excitation devices may be provided, in which one excitation device forms a rectangle around the receivers 10.23, 10.24 and a further excitation device forms a rectangle around the receivers 10.25, 10.26.

The first field interaction devices 10.X1, 10.X1′, 10.X1″, 10.X2, 10.X2′, 10.X2″, 10.Y1, 10.Y1′, 10.Y1″, 10.Y2, 10.Y2′, 10.Y2″ are arranged within the first interaction surface 11 of the first assembly 10. The first interaction surface 11 is the surface of a circuit board produced by a thin-film technique and, additionally or alternatively, by a thick-film technique. To configure the structured first field interaction devices 10.X1, 10.X1′, 10.X1″, 10.X2, 10.X2′, 10.X2″, 10.Y1, 10.Y1′, 10.Y1″, 10.Y2, 10.Y2′, 10.Y2″, multiple separate superimposed and electrically conductive layers may be provided that are separated from each other by insulating layers. At predefined points, referred to as vias, there is an electrical connection between the conductive paths of the various electrically conductive layers.

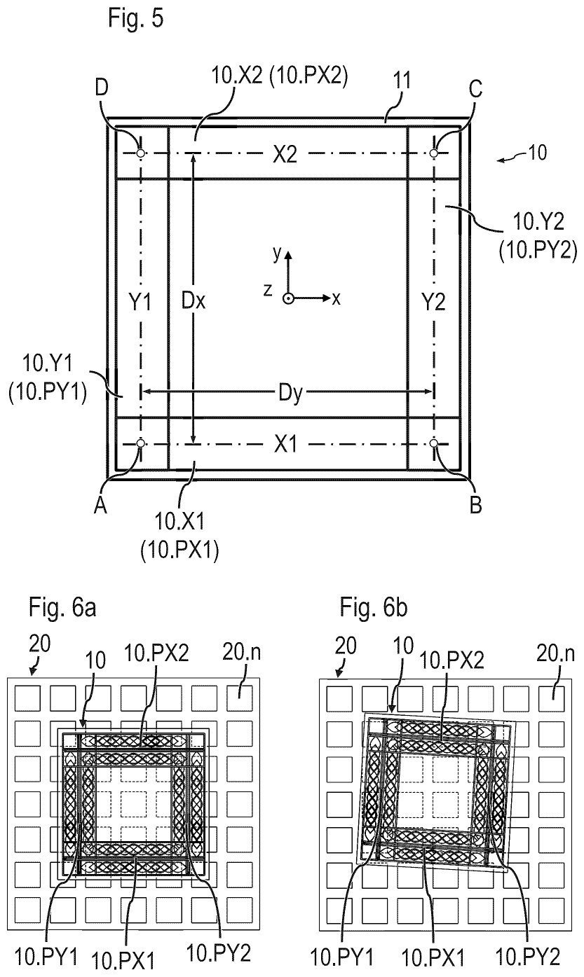

As illustrated in FIG. 5, the two first field interaction devices 10.X1, 10.X2 or the two field interaction pairs 10.PX1, 10.PX2 extend parallel to the first direction x and are arranged at a distance Dx from each other. The two first field interaction devices 10.Y1, 10.Y2 or the two field interaction pairs 10.PY1, 10.PY2 extend parallel to the second direction y and are also arranged at a distance Dy from each other. For example, the arrangement of the first field interaction devices 10.X1, 10.X2, 10.Y1, 10.Y2 and of the field interaction pairs 10.PX1, 10.PX2, 10.PY1, 10.PY2 corresponds to a quadrilateral arrangement, e.g., in the form of a square (Dx=Dy).

For example, the individual first field interaction devices 10.X1, 10.X2, 10.Y1, 10.Y2 or the field interaction pairs 10.PX1, 10.PX2, 10.PY1, 10.PY2 of the quadrilateral arrangement partially or completely overlap in the corners A, B, C, D of the quadrilateral arrangement.

Overlapping means an overlapping of at least two adjacent and orthogonal first field interaction devices 10.X1, 10.X1′, 10.X1″, 10.X2, 10.X2′, 10.X2″, 10.Y1, 10.Y1′, 10.Y1″, 10.Y2, 10.Y2′, 10.Y2″ or field interaction pairs 10.PX1, 10.PX2, 10.PY1, 10.PY2, as seen in a top view viewed in the third direction z.

Partial overlapping means that the overlapping area of the at least two adjacent and orthogonal first field interaction devices 10.X1, 10.X1′, 10.X1″, 10.X2, 10.X2′, 10.X2″, 10.Y1, 10.Y1′, 10.Y1″, 10.Y2, 10.Y2′, 10.Y2″ or field interaction pairs 10.PX1, 10.PX2, 10.PY1, 10.PY2 does not correspond to the largest possible overlapping area.

Complete overlapping means that the overlapping area of the at least two adjacent and orthogonal first field interaction devices 10.X1, 10.X1′, 10.X1″, 10.X2, 10.X2′, 10.X2″, 10.Y1, 10.Y1′, 10.Y1″, 10.Y2, 10.Y2′, 10.Y2″ or field interaction pairs 10.PX1, 10.PX2, 10.PY1, 10.PY2 correspond to the largest possible overlapping area.

For example, a complete overlapping of all adjacent first field interaction devices 10.X1, 10.X1′, 10.X1″, 10.X2, 10.X2′, 10.X2″, 10.Y1, 10.Y1′, 10.Y1″, 10.Y2, 10.Y2′, 10.Y2″ or field interaction pairs 10.PX1, 10.PX2, 10.PY1, 10.PY2 occurs in all four corners A, B, C, D of the quadrilateral arrangement, so that the first interaction surface 11 is as small as possible, whereby a particularly compact first assembly 10 may be obtained. For example, the individual first field interaction devices 10.X1, 10.X1′, 10.X1″, 10.X2, 10.X2′, 10.X2″, 10.Y1, 10.Y1′, 10.Y1″, 10.Y2, 10.Y2′, 10.Y2″ or field interaction pairs 10.PX1, 10.PX2, 10.PY1, 10.PY2 protrude only slightly or not at all in the corners A, B, C, D.

For example, when arranging the first field interaction devices 10.X1, 10.X1′, 10.X1″, 10.X2, 10.X2′, 10.X2″, 10.Y1, 10.Y1′, 10.Y1″, 10.Y2, 10.Y2′, 10.Y2″ to form field interaction pairs 10.PX1, 10.PX2, 10.PY1, 10.PY2, it may be provided that, as illustrated in FIGS. 1, 6a and 6b, there is a (complete) overlapping of the excitation device 10.2 and receivers 10.23, 10.24, 10.25, 10.26 of the adjacent inner first field interaction devices 10.X1″, 10.X2″, 10.Y1″, 10.Y2″ in the corners A, B, C, D for the inner first field interaction devices 10.X1″, 10.X2″, 10.Y1″, 10.Y2″. In the case of the external first field interaction devices 10.X1′, 10.X2′, 10.Y1′, 10.Y2′, there is a (complete) overlapping of the excitation device 10.2, but not of the receivers 10.23, 10.24, 10.25, 10.26.

However, an overlapping of the excitation device 10.2 and the receivers 10.23, 10.24, 10.25, 10.26 is also possible both for the internal first field interaction devices 10.X1″, 10.X2″, 10.Y1″, 10.Y2″ and for the external first field interaction devices 10.X1′, 10.X2′, 10.Y1′, 10.Y2′.

Via the two receivers 10.21, 10.22, 10.23, 10.24, 10.25, 10.26 of each first field interaction device 10.X1, 10.X2, 10.Y1, 10.Y2 or each field interaction pair 10.PX1, 10.PX2, 10.PY1, 10.PY2, in which the receivers are offset in the first direction x or in the second direction y, each field interaction device 10.X1, 10.X2, 10.Y1, 10.Y2 or each field interaction pair 10.PX1, 10.PX2, 10.PY1, 10.PY2 supplies two measured variables in the form of a 0° signal and a 90° signal, so that a total of eight measured variables may be used for position determination.

For each field interaction device 10.X1, 10.X2, 10.Y1, 10.Y2 or field interaction pair 10.PX1, 10.PX2, 10.PY1, 10.PY2, a linear position value in the corresponding direction x, y and a signal amplitude are first determined from the 0° and 90° signals. The signal amplitude may be used to form a distance value. The distance value of a first field interaction device 10.X1, 10.X2, 10.Y1, 10.Y2 or field interaction pair 10.PX1, 10.PX2, 10.PY1, 10.PY2 quantifies the distance of the corresponding field interaction device 10.X1, 10.X2, 10.Y1, 10.Y2 or field interaction pair 10.PX1, 10.PX2, 10.PY1, 10.PY2 to the second interaction surface 21 of the second assembly 20 in the third direction z.

As illustrated in FIG. 5, the first field interaction device 10.X1 or the field interaction pair 10.PX1 provides a first measurement information X1 including a first position value for the first direction x and a first signal amplitude for determining a position value for the third direction z. Analogously, the first field interaction device 10.X2 or the field interaction pair 10.PX2 provides a second measurement information X2 including a second position value for the first direction x and a second signal amplitude for the determination of a position value for the third direction z. The first field interaction device 10.Y1 or the field interaction pair 10.PY1 provides a third measurement information Y1 including a third position value for the second direction y and a third signal amplitude for the determination of a position value for the third direction z. The first field interaction device 10.Y2 or the field interaction pair 10.PY2 provides a fourth measurement information Y2 including a fourth position value for the second direction y and a fourth signal amplitude for the determination of a position value for the third direction z.

Consequently, the inductive position measuring device 1 provides two pieces of measurement information X1, X2 for the first direction x and two pieces of measurement information Y1, Y2 for the second direction y during a measurement cycle, in which each of the pieces of measurement information X1, X2, Y1, Y2 is composed of or includes at least one position value and at least one signal amplitude.

In this manner, the relative position and orientation of the first assembly 10 with respect to the second assembly 20 may be determined in up to six degrees of freedom.

FIGS. 6a and 6b are top view of the inductive position measuring device 1, in which, in the first assembly 10, only the first interaction surface 11 with multiple first field interaction devices 10.X1′, 10.X1″, 10.X2′, 10.X2″, 10.Y1′, 10.Y1″, 10.Y2′, 10.Y2″ arranged in pairs is illustrated. The first and second assemblies 10, 20 are opposite each other and are arranged in two parallel planes so that an air gap is formed between the first and second assemblies 10, 20. The first assembly 10 is illustrated in FIG. 6a in a first position. FIG. 6b illustrates the first assembly 10 at a later point in time, in which it is deflected and has assumed a second position. During the transition from the first to the second position, the first assembly 10 has performed a relative rotation about the coordinate axis of the third direction z. The second assembly 20 remained immobile and stationary. The inductive position measuring device 1 is configured to determine and evaluate one or more relative rotations of the first assembly 10 in the three directions x, y, z.

As illustrated in FIGS. 6a and 6b, position determination is, for example, performed on the basis of those field interaction pairs 10.PX1, 10.PX2, 10.PY1, 10.PY2 in which a sufficiently strong coupling forms, i.e., for those field interaction pairs 10.PX1, 10.PX2, 10.PY1, 10.PY2 and second field interaction devices 20.1 to 20.n that at least partially overlap in a top view as seen in the third direction z. For example, the first field interaction devices 10.X1′, 10.X1″, 10.X2′, 10.X2″, 10.Y1′, 10.Y1″, 10.Y2′, 10.Y2″ are larger than the second field interaction devices 20.1 to 20.n, so that multiple second field interaction devices 20.1 to 20.n are always overlapped by at least one first field interaction device 10.X1′, 10.X1″, 10.X2′, 10.X2″, 10.Y1′, 10.Y1″, 10.Y2′, 10.Y2″. For example, the receivers 10.23, 10.24, 10.25, 10.26 of the first field interaction device 10.X1′, 10.X1″, 10.X2′, 10.X2″, 10.Y1′, 10.Y1″, 10.Y2′, 10.Y2″ overlap multiple second field interaction devices 20.1 to 20.n.

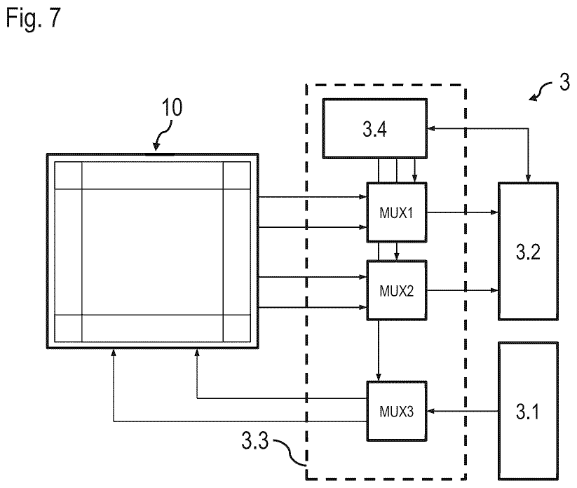

FIG. 7 is a block diagram of evaluation electronics 3 of the inductive position measuring device 1.

The evaluation electronics 3 includes an excitation circuit as a signal generator module 3.1, an application-specific integrated circuit (ASIC) as an evaluation module 3.2, and a switching unit 3.3. To store current and historical speeds, the evaluation module 3.2 may also access a non-volatile memory module.

The switching unit 3.3 includes a control module 3.4, for example, a microcontroller, which controls three multiplexers MUX1, MUX2, MUX3 and also communicates with the processing unit 3.2.

The individual first field interaction devices 10.X1, 10.X2, 10.Y1, 10.Y2; 10.X1′, 10.X1″, 10.X2′, 10.X2″, 10.Y1′, 10.Y1″, 10.Y2′, 10.Y2″ or field interaction pairs 10.PX1, 10.PX2, 10.PY1, 10.PY2 are connected to the evaluation electronics 3, and the evaluation electronics 3 operates the individual first field interaction devices 10.X1, 10.X2, 10.Y1, 10.Y2; 10.X1′, 10.X1″, 10.X2′, 10.X2″, 10.Y1′, 10.Y1″, 10.Y2′, 10.Y2″ or field interaction pairs 10.PX1, 10.PX2, 10.PY1, 10.PY2 cyclically and alternately with a predetermined switching frequency.

The predetermined switching frequency, which specifies the switching frequency between a terminal of predetermined first field interaction devices 10.X1, 10.X2, 10.Y1, 10.Y2; 10.X1′, 10.X1″, 10.X2′, 10.X2″, 10.Y1′, 10.Y1″, 10.Y2′, 10.Y2″ or field interaction pairs 10.PX1, 10.PX2, 10.PY1, 10.PY2 to the signal generator module 3.1 or the evaluation module 3.2, is selected by the switching unit 3.3 such that a reliable position and alignment determination is performed.

This may be performed, for example, by an adaptive switching frequency that is continuously adjusted depending on the historical relative speeds and, additionally or alternatively, the current relative speed of the deflection of the first assembly 10. The predetermined switching frequency is always selected so that the position and alignment may be reliably determined in real time. If the first module 10 is deflected quickly, a correspondingly increased switching frequency is selected. If there is no deflection of the first assembly 10 or only a slight deflection, a constant or correspondingly reduced switching frequency is used.

For example, those field interaction pairs 10.X1, 10.X2; 10.Y1, 10.Y2, which are arranged parallel to each other and along an identical direction x, y, are operated simultaneously. This means that only the field interaction pairs 10.PX1 and 10.PX2 extending in the first direction x are initially operated within a measuring cycle. The excitation devices 10.2 of the two field interaction pairs 10.PX1, 10.PX2 are temporarily connected to the signal generator module 3.1, and the receivers 10.23, 10.24, 10.25, 10.26 of the two field interaction pairs 10.PX1, 10.PX2 are separately connected to the evaluation module 3.2. Subsequently, only the field interaction pairs 10.PY1, 10.PY2 extending in the second direction y are operated. The excitation devices 10.2 of the two field interaction pairs 10.PY1, 10.PY2 are temporarily connected to the signal generator module 3.1, and the receivers 10.23, 10.24, 10.25, 10.26 of the two field interaction pairs 10.PY1, 10.PY2 are separately connected to the evaluation module 3.2.

The alternating operation of the first field interaction devices 10.X1, 10.X2, 10.Y1, 10.Y2; 10.X1′, 10.X1″, 10.X2′, 10.X2″, 10.Y1′, 10.Y1″, 10.Y2′, 10.Y2″ or field interaction pairs 10.PX1, 10.PX2, 10.PY1, 10.PY2 in the first and second direction x, y results in the advantage that electronic components may be saved within the evaluation electronics, as only one signal generator module 3.1 and only one processing module 3.2 are required, which are used in the same manner for both directions x, y.

The position determination is performed within a predefined measuring range according to an absolute measuring method. The measuring range depends on the length of the first field interaction devices 10.X1, 10.X2, 10.Y1, 10.Y2; 10.X1′, 10.X1″, 10.X2′, 10.X2″, 10.Y1′, 10.Y1″, 10.Y2′, 10.Y2″ in the corresponding first or second direction x, y or on the resulting 0° and 90° signals.

At the start of the measurement, the first and second assemblies 10, 20 are oriented relative to each other in a defined manner within the measuring range, for example. by centering the first assembly 10 relative to the second assembly 20 (see, e.g., FIG. 6a). If there is a relative deflection of the first assembly 10 in relation to the second assembly 20, the absolute position of the first assembly within the measuring range may be determined.

For example, the area of the second interaction surface 21 is less than or equal to the area of the measuring range.

What is claimed is:

1. An inductive position measuring device, comprising:
a first assembly including a first interaction surface and at least four first field interaction devices arranged parallel to the first interaction surface and connected to evaluation electronic, the first field interaction devices being arranged as linear sensors and as a quadrilateral along a first direction and a second direction, the first field interaction devices overlapping at least partially in corners of the quadrilateral arrangement; and
a second assembly including a second interaction surface and multiple second field interaction devices arranged in a flat manner distributed over the second interaction surface, the first assembly and the second assembly being arranged opposite each other in a third direction and being movable relative to each other;
wherein the first and second field interaction devices are configured to be brought into electromagnetic interaction with each other.

2. The position determination system according to claim 1, wherein each first field interaction device includes at least one excitation device configured to generate an electromagnetic field and at least one receiver configured to receive an electromagnetic field.

3. The inductive position measuring device according to claim 2, wherein each first field interaction device includes a first receiver and a second receiver having a periodic curve with a constant period length, the receivers being arranged offset from each other by a quarter of the period length in the first direction or the second direction, and an excitation device that surrounds the two receivers.

4. The inductive position measuring device according to claim 1, wherein the first assembly includes four first field interaction devices that are arranged in the first interaction surface and perpendicular to each other.

5. The inductive position measuring device according to claim 3, wherein the first assembly includes four first field interaction devices that are arranged in the first interaction surface and perpendicular to each other, and the receivers of the four first field interaction devices have a peak-to-peak amplitude that corresponds to at least one period length.

6. The inductive position measuring device according to claim 1, wherein the first assembly includes eight first field interaction devices arranged in the first interaction surface and in four pairs of parallel field interaction pairs arranged perpendicular to each other.

7. The inductive position measuring device according to claim 3, wherein the first assembly includes eight first field interaction devices arranged in the first interaction surface and in four pairs of parallel field interaction pairs arranged perpendicular to each other, the first receivers of at least one field interaction pair being identical and connected in series, the second receivers of at least one field interaction pair being identical and connected in series, the receivers of the field interaction pairs having a peak-to-peak amplitude that is less than half the period length, a distance between two receivers of at least one field interaction pair being half the period length.

8. The inductive position measuring device according to claim 1, wherein the second field interaction devices are arranged in a quadrangle or a square, are of equal size, and are arranged in a grid evenly distributed on the second interaction surface.

9. The inductive position measuring device according to claim 1, wherein the quadrilateral is a rectangle or a square.

10. The inductive position measuring device according to claim 1, wherein the second field interaction devices are produced using planar technology, a thick-film technique, and/or a thin-film technique.

11. The inductive position measuring device according to claim 1, wherein the evaluation electronics is configured to operate the first field interaction devices at a predetermined switching frequency.

12. The inductive position measuring device according to claim 11, wherein the predetermined switching frequency is dependent on a current relative speed and/or historical relative speeds of the first assembly and/or the second assembly.

13. The inductive position measuring device according to claim 1, wherein the evaluation electronics includes at least one signal generator module, at least one evaluation module, and at least one switching unit, the first field interaction devices being connected either individually or in pairs to either the evaluation module or the signal generator module via the switching unit.

14. The inductive position measuring device according to claim 13, wherein the switching unit includes at least one multiplexer and at least one control module configured to control the multiplexer depending on the switching frequency to perform a pairwise connection of the first field interaction devices extending in an identical direction with the evaluation module or the signal generation module.

15. The inductive position measuring device according to claim 1, wherein the second assembly is not connected to an active power supply and data processing.

16. The inductive position measuring device according to claim 1, wherein the first assembly and the second assembly are arranged in parallel, a gap being located between the first assembly and the second assembly.

17. The inductive position measuring device according to claim 1, wherein the second field interaction devices are arranged as elevations on a metal substrate.

18. The inductive position measuring device according to claim 17, wherein regions between individual second field interaction devices are arranged as empty spaces.

19. The inductive position measuring device according to claim 17, wherein regions between individual second field interaction devices are filled with an epoxy resin.

20. The inductive position measuring device according to claim 1, wherein the second field interaction devices are arranged in a grid unevenly distributed on the second interaction surface.
